(19) United States
(12) Patent Application Publication
(10) Pub. No.: US 2008/0133575 A1
(43) Pub. Date: Jun. 5, 2008

(54) Audio reproducing apparatus, metadata acquiring system for audio reproducing apparatus and metadata acquiring method for audio reproducing apparatus

(75) Inventor: Toshihiro Morohoshi, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/907,767

(22) Filed: Oct. 17, 2007

(30) Foreign Application Priority Data
Nov. 30, 2006 (JP) 2006-324470

(51) Int. Cl. G06F 17/00

(52) U.S. Cl. 707/102; 707/E17.102

(57) ABSTRACT

According to one embodiment, there is provided an audio reproducing apparatus including a recording section which records audio information without metadata, a generating section which generates a fingerprint of the audio information, a communicating section which carries out communication with an external device, and an acquiring section which supplies the fingerprint generated by the generating section to the external device via the communicating section and acquires metadata from the external device.

### CROSS-REFERENCE TO RELATED APPLICATIONS

This application is based upon and claims the benefit of priority from Japanese Patent Application No. 2006-324470, filed Nov. 30, 2006, the entire contents of which are incorporated herein by reference.

### BACKGROUND

1. Field

One embodiment of the invention relates to an audio reproducing apparatus which acquires metadata of audio information, a metadata acquiring system for the audio reproducing apparatus and a metadata acquiring method for the audio reproducing apparatus.

2. Description of the Related Art

Recently, apparatuses, which convert an audio signal of music into digital information so as to record and reproduce the digital information in/from digital apparatuses, come into very wide use. In such audio reproducing apparatuses, each audio information is managed by metadata such as song title, artist name and album name, so that huge amount of audio information can be managed easily under user's hand.

Patent Document 1 (Jpn. Pat. Appln. KOKAI Publication No. 2004-234158) discloses a system in which metadata is used as management information of audio information. The metadata is shared between a portable device and a server so as to be used as management information of audio information.

In the conventional technique of Patent Document 1, however, although plural pieces of audio information are managed between a plurality of devices by the metadata, the conventional technique does not provide a method for acquiring and managing metadata for audio information whose metadata cannot be acquired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory diagram illustrating one example of connection between an audio reproducing apparatus and PC according to one embodiment of the present invention;

FIG. 2 is a block diagram illustrating one example of a constitution of a site on a network of an audio system, the PC and the audio reproducing apparatus according to one embodiment of the present invention;

FIG. 3 is a flowchart illustrating one example of a metadata acquiring process in the audio reproducing apparatus according to one embodiment of the present invention;

FIG. 4 is a flowchart illustrating another example of the metadata acquiring process of the audio reproducing apparatus according to one embodiment of the present invention; and

FIG. 5 is an explanatory diagram illustrating one example of a selection screen for selecting metadata candidates in the audio reproducing apparatus according to one embodiment of the present invention.

### DETAILED DESCRIPTION

Various embodiments according to the invention will be described hereinafter with reference to the accompanying drawings. In general, according to one embodiment of the invention, there are provided an audio reproducing apparatus and an audio reproducing method which can acquire and manage metadata easily for audio information without metadata via an external device such as PC.

One embodiment for achieving the object is an audio reproducing apparatus including:

a recording section (14) which records audio information without metadata;

a generating section (17) which generates a fingerprint of the audio information;

a communicating section (11) which carries out communication with an external device; and

an acquiring section (18-2) which supplies the fingerprint generated by the generating section to an external device (P) via the communicating section and acquires metadata from the external device.

As a result, metadata can be easily acquired and managed for an audio signal originally having no metadata, such as an analog audio signal recorded from a cassette tape.

Embodiments of the present invention will be described in detail below with reference to the drawings.

<Audio Reproducing Apparatus and Information Processing Apparatus According to One Embodiment of the Present Invention>

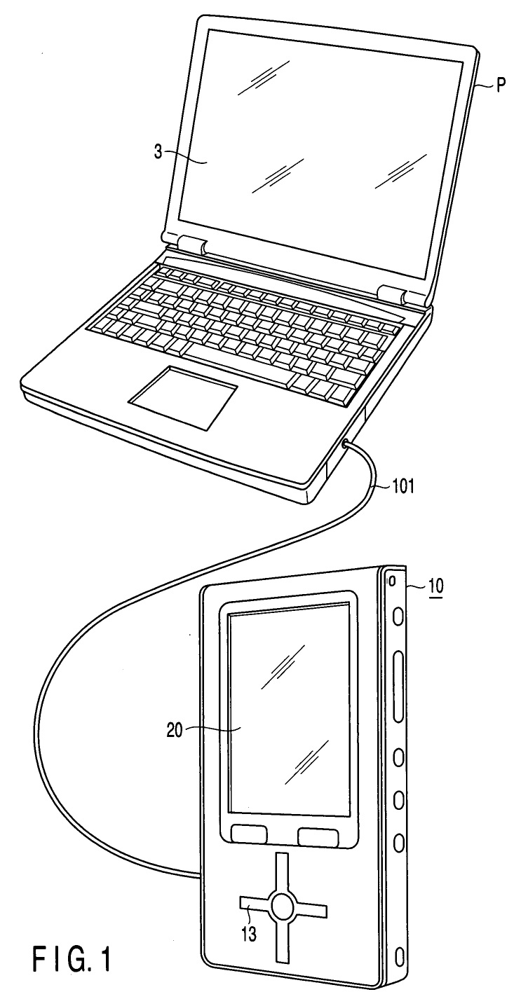

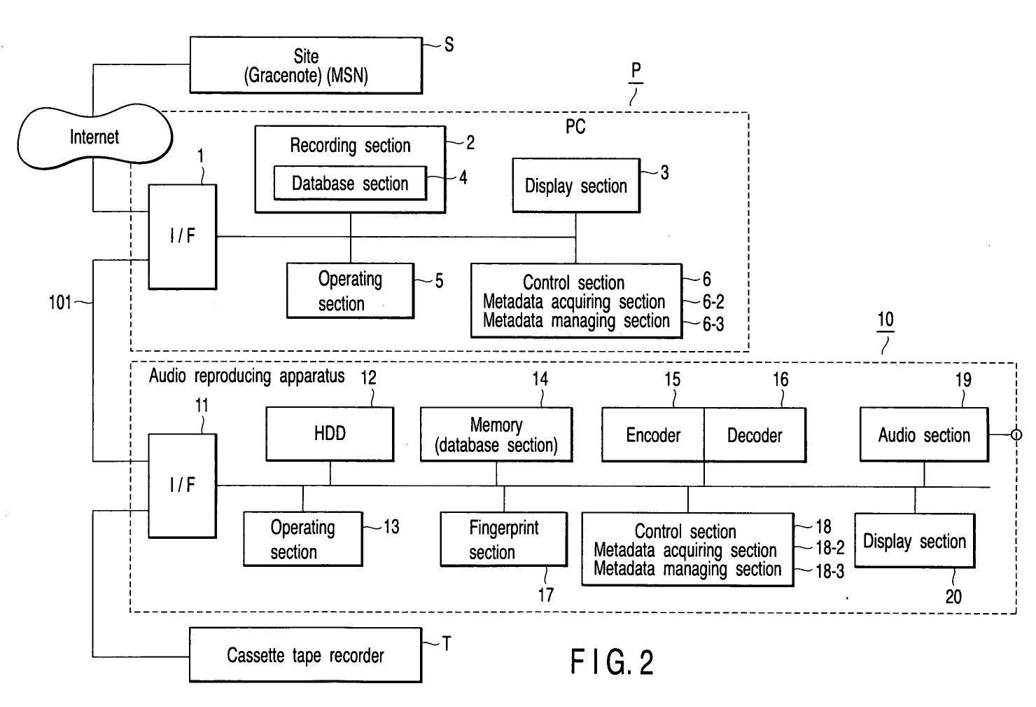

The audio reproducing apparatus and the information processing apparatus according to one embodiment of the present invention will be described in detail below with reference to the drawings. FIG. 1 is an explanatory diagram illustrating one example of connection between the audio reproducing apparatus and PC according to one embodiment of the present invention. FIG. 2 is a block diagram illustrating one example of a constitution of a site on a network of an audio system, the PC and the audio reproducing apparatus according to one embodiment of the present invention.

(Information Processing Apparatus)

An information processing apparatus P and an audio reproducing apparatus 10 to be connected to the apparatus P according to one embodiment of the present invention are connected by an USB cable 101, for example, as shown in FIGS. 1 and 2.

The information processing apparatus P includes an I/F section 1, a control section 6 which controls the entire apparatus, a metadata acquiring section 6-2 and a metadata managing section 6-3 included in the control section 6, an operating section 5 such as a keyboard, a recording section 2 such as an HDD (Hard Disk Driver) including a database section 4, and a display 3 such as a liquid crystal display section. The information processing apparatus P can communicate with a server S on a site, which can detect metadata of audio information (title, artist name, album name) based on a fingerprint of the audio information as mentioned later, by way of the Internet using the I/F section 1.

(Audio Reproducing Apparatus)

The audio reproducing apparatus 10 according to one embodiment of the present invention includes an I/F section 11, a control section 18 which is connected to respective sections via a flat cable so as to control an entire operation, a metadata acquiring section 18-2 and a metadata managing section 18-3 included in the control section 18, and an HDD (Hard Disc Driver) 12 which records audio information and the like as shown in FIGS. 1 and 2. The audio reproducing apparatus 10 further includes an operating section 13 such as operation keys, a memory 14, an encoder 15, a decoder 16, a fingerprint section 17, an audio section 19, and a display section 20. The memory 14 stores management information and the like of metadata therein. The encoder 15 encodes audio information. The decoder 16 decodes encoded audio information. The fingerprint section 17 generates a fingerprint (data) which is a hash value of the audio information obtained by a hash function. The audio section 19 processes audio information into an output enabled state. The display section 20 displays operation information and management information.

For example, an analog audio signal is retrieved from a cassette tape recorder T via the I/F section 11 and is encoded as a digital audio signal by the encoder section 15 so as to be recorded in the HDD 12. The audio information can be reproduced and output as a reproduced signal from the audio section 19 according to an operation of the operating section 13.

(Metadata Acquiring Process and Managing Process)

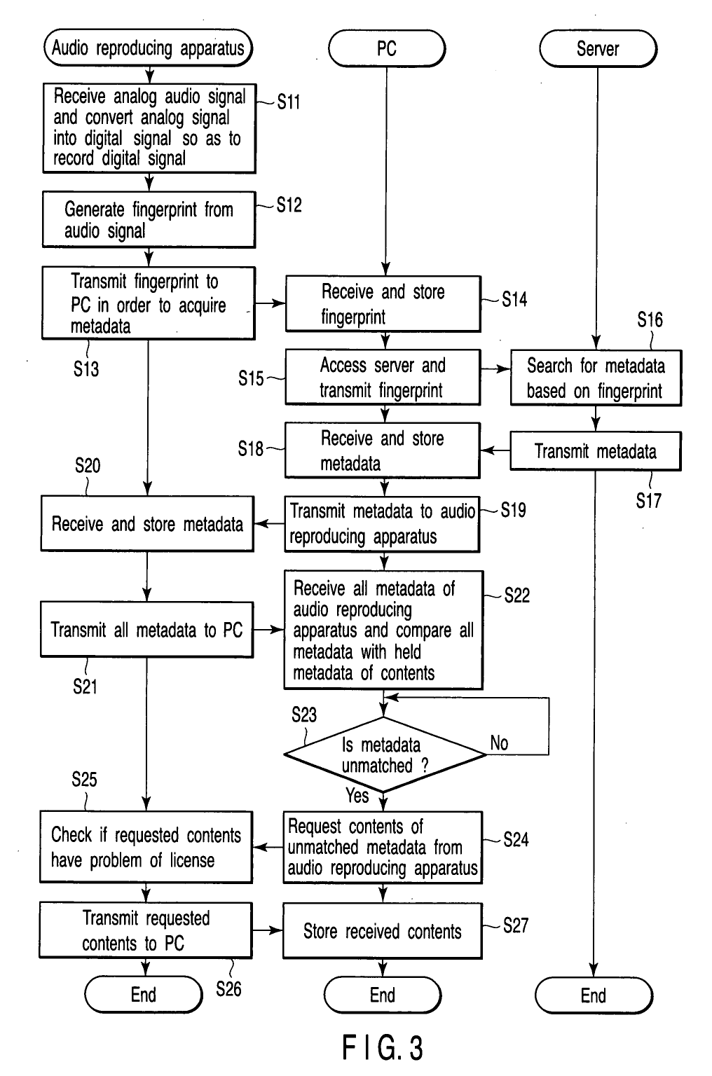

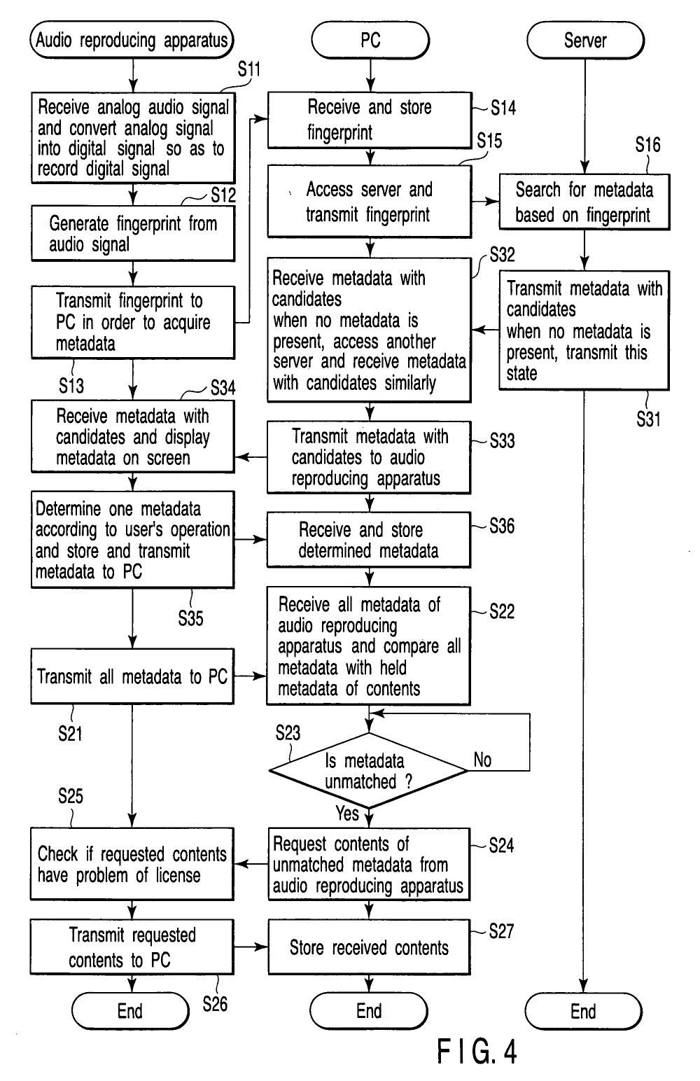

The metadata acquiring process and the managing process by means of the audio reproducing apparatus 10 and the information processing apparatus P having the above constitutions will be described in detail below with reference to flowcharts of FIGS. 3 and 4. FIG. 3 is a flowchart illustrating one example of the metadata acquiring process in the audio reproducing apparatus according to one embodiment of the present invention. FIG. 4 is a flowchart illustrating one example of the metadata acquiring process with a screen for selecting metadata candidates.

Respective steps in the flowcharts of FIGS. 3 and 4 can be replaced by circuit blocks, and therefore, all the steps of the flowcharts can be redefined as blocks.

In the audio reproducing apparatus 10 and the information processing apparatus P according to one embodiment of the present invention, the audio reproducing apparatus 10 receives an analog audio signal from the cassette tape recorder T, for example, and converts the analog signal into a digital signal so as to record the digital signal in the HDD 12 (step S11). Particularly the digital audio signal which is recorded by loading such an analog audio does not have metadata.

Under the control of the metadata acquiring section 18-2 of the control section 18, therefore, the fingerprint section 17 generates a fingerprint of the digital audio signal (step S12). Thereafter, under the control of the metadata acquiring section 18-2, the fingerprint (data) is transmitted to the information processing apparatus P via the I/F section 11 in order to acquire metadata (step S13).

In the information processing apparatus P, the fingerprint is received via the I/F section 1 and is stored in the database section 4 of the recording section 2 (step S14). Under the control of the metadata acquiring section 6-2 of the control section 6, the information processing apparatus P accesses the server S which provides the metadata (song title, artist name and album name) based on the fingerprint via the I/F section 1 by way of the Internet so as to transmit the fingerprint to the server S (step S15).

In the server S, a database, not shown, is searched for the corresponding metadata based on the received fingerprint (step S16). When the corresponding metadata is present, the server S supplies the metadata to the information processing apparatus P by way of the Internet (step S17).

In the information processing apparatus P, the metadata managing section 6-3 receives the metadata and stores the metadata in the database section 4 of the recording section 2 (step S18). The metadata managing section 6-3 transmits the metadata to the audio reproducing apparatus 10 via the I/F section 1 and the I/F section 11 (step S19).

In the audio reproducing apparatus 10, the metadata acquiring section 18-2 receives the metadata so as to store the metadata in the database section of the memory 14 (step S20). The metadata managing section 18-3 transmits all the metadata stored in the database section to the information processing apparatus P via the I/F section 11 (step S21).

In the information processing apparatus P, the metadata managing section 18-3 receives all the metadata in the audio reproducing apparatus 10, and compares the received metadata with its own metadata, stored in the database section 4 (step S22). When the metadata managing section 18-3 detects mismatching of the metadata (step S23), the metadata managing section 18-3 requests contents corresponding to the mismatched metadata from the audio reproducing apparatus 10 (step S24).

The audio reproducing apparatus 10 checks whether the requested contents have no problem of license (step S25). When having no problem, the requested contents are transmitted to the information processing apparatus P via the I/F sections 11 and 1 (step S26). In the information processing apparatus P, the received contents (audio information) are stored in the database section 4 (step S27). As a result, the contents information can be synchronized with each other between the audio reproducing apparatus 10 and the information processing apparatus P.

The processes in the cases where a plurality of metadata candidates are present and no metadata is present

The processes in the cases where a plurality of metadata candidates are present and no metadata is present will be described below with reference to the flowchart of FIG. 4. When the steps in FIG. 4 are equivalent to those in FIG. 3, description thereof will be omitted.

That is to say, when the server S searches the database, not shown, for metadata based on the fingerprint at step S16 and the metadata is not found, the server S posts this state to the information processing apparatus P (step S31). On the contrary, the information processing apparatus P accesses the server S on a site with another address having the similar function, so as to try to acquire metadata according to the similar procedure (step S32).

When the server S searches the database, not shown, for metadata based on the fingerprint at step S31 and a plurality of metadata candidates are found, the server S transmits all the metadata candidates (or some of them) to the information processing apparatus P (step S31). In the information processing apparatus P, the metadata candidates are transmitted to the audio reproducing apparatus 10 (step S33).

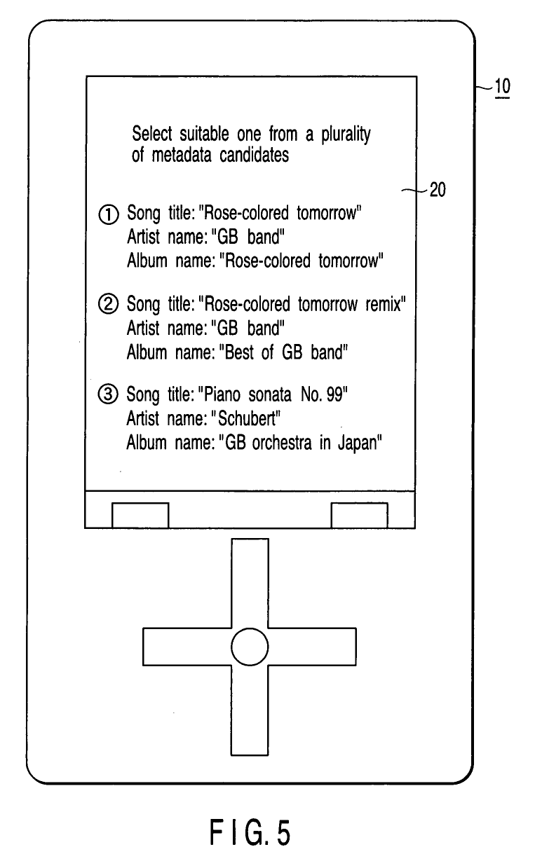

In the audio reproducing apparatus 10, a plurality of metadata candidates are displayed on a screen as in a display screen 20 shown in FIG. 5 (step S34). On the contrary, a user operates the operating section 13 to specify “1”, for example, as an optimal candidate, and the metadata acquiring section 18-2 determines metadata according to the contents based on the operation signal (step S35). At this time, the determined metadata is stored in the database section of the memory 14, and is simultaneously transmitted to the information processing apparatus P via the I/F sections 1 and 11 (step S35).

In the information processing apparatus P, the metadata managing section 6-3 stores the transmitted and determined metadata in the database section 4 and the like (step S36).

As a result, in either case where no metadata is found on the site or a plurality of metadata candidates are present, optimum metadata can be acquired and managed.

In the process hereafter in FIG. 4, the contents are synchronized based on the metadata similarly to the case of FIG. 3.

In the audio reproducing apparatus and the information processing apparatus according to one embodiment of the present invention, metadata cannot be retrieved at the time of recording, but at the time when the audio reproducing apparatus is connected to the information processing apparatus, the audio reproducing apparatus accesses the server S so as to acquire metadata collectively. Suitable metadata is acquired even for analog music information with no metadata recorded in an old-time cassette tape recorder by using fingerprint information and a personal computer, so that digital audio information recorded from an analog audio can be managed by using the acquired metadata.

The above audio reproducing apparatus 10 handles only audio information, but it can preferably handle also still image information, moving image information and the other digital information. The present invention can be applied to such an audio reproducing apparatus to the same effect.

A person skilled in the art can realize the present invention in the above various embodiments, but the person skilled in the art easily conceives of various modified examples of the embodiments, and thus can apply the present invention to various embodiments without inventive ability. Therefore, the present invention covers a wide range which does not contradict the disclosed principle and new characteristics, and is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio reproducing apparatus comprising:
a recording section which records audio information without metadata;
a generating section which generates a fingerprint of the audio information;
a communicating section which carries out communication with an external device; and
an acquiring section which supplies the fingerprint generated by the generating section to an external device via the communicating section and acquires metadata from the external device.

2. The audio reproducing apparatus according to claim 1, wherein after the acquiring section acquires the metadata from the external device, the acquiring section transmits all held metadata to the external device via the communicating section.

3. The audio reproducing apparatus according to claim 1, wherein after all the metadata are transmitted to the external device, if contents are requested by the external device, the contents are transmitted to the external device via the communicating section.

4. The audio reproducing apparatus according to claim 1, wherein when a plurality of metadata candidates are received from the external device, the metadata candidates are displayed on a screen, and one metadata is determined according to an operation signal so as to be saved.

5. A metadata acquiring system for an audio reproducing apparatus and an information processing apparatus to be connected to the audio reproducing apparatus, comprising:
the audio reproducing apparatus including a recording section which records audio information without metadata, a generating section which generates a fingerprint of the audio information, a communicating section which carries out communication with the information processing apparatus, a first metadata acquiring section which supplies the fingerprint generated by the generating section to the information processing apparatus via the communicating section and acquires metadata from the information processing apparatus, and a first metadata managing section which manages the metadata; and
the information processing apparatus including a communicating section which communicates with the audio reproducing apparatus and a server, a second metadata acquiring section which receives the fingerprint from the audio reproducing apparatus and supplies the fingerprint to the server via the communicating section so as to acquire metadata corresponding to the fingerprint from the server, and a second metadata managing section which supplies the metadata to the audio reproducing apparatus via the communicating section.

6. The metadata acquiring system according to claim 5, wherein the first metadata managing section of the audio reproducing apparatus acquires the metadata from the information processing apparatus and supplies all the other metadata to the information processing apparatus,
the second metadata managing section of the information processing apparatus compares the other metadata with held metadata and when insufficient metadata is present, requests contents corresponding to the insufficient metadata from the audio reproducing apparatus, and
the first metadata managing section of the audio reproducing apparatus transmits the contents to the information processing apparatus in response to the request of the contents of the insufficient metadata from the second metadata managing section.

7. The metadata acquiring system according to claim 5, wherein when metadata is not acquired from the server, the second metadata acquiring section of the information processing apparatus accesses a second server so as to acquire metadata.

8. The metadata acquiring system according to claim 5, wherein the second metadata acquiring section of the information processing apparatus receives a plurality of metadata candidates from the server so as to transmit the metadata candidates to the audio reproducing apparatus, and
the first metadata acquiring section of the audio reproducing apparatus displays said plurality of metadata candidates on a screen so as to determine one metadata according to an operation signal.

9. A metadata acquiring method for an audio reproducing apparatus using an information processing apparatus, comprising:
storing audio information without metadata in the audio reproducing apparatus;
generating a fingerprint of the audio information;
supplying the fingerprint to the information processing apparatus via a communication line;
supplying the fingerprint to an external server via the communication line so as to acquire metadata corresponding to the fingerprint from the server in the information processing apparatus; and
supplying the metadata to the audio reproducing apparatus via the communication line.
